(19) United States
(12) Patent Application Publication
(10) Pub. No.: US 2005/0248832 A1
(43) Pub. Date: Nov. 10, 2005

(54) Gain-Flattening apparatus and methods and optical amplifiers employing same

(76) Inventors: Rad Sommer, Sebastopol, CA (US); Michael Scobey, Santa Rosa, CA (US); Rance Morgan Fortenberry, Cazadero, CA (US); Toby Reid, Torquay (GB); Paul Johnson, Torquay (GB)

Correspondence Address: BANNER & WITCOFF, LTD., 28 STATE STREET, 28th FLOOR, BOSTON, MA, 02109-9601, US

(21) Appl. No.: 10/874,559

(22) Filed: Jun. 23, 2004

(30) Foreign Application Priority Data
May 10, 2004 (GB) 0410233.1

(51) Int. Cl. H01S 3/00

(52) U.S. Cl. 359/337

(57) ABSTRACT

A gain-flattening filter for in-line compensation of the spectral gain profile of an optical amplifier comprises: a first GFF component having a transmission curve with a spectral loss profile corresponding to the spectral gain profile of an optical amplifier, and a second GFF component having a transmission curve with a spectral loss profile corresponding to the error function of the first GFF component. A method of producing a gain-flattening filter for use with an optical amplifier comprises: designing a first GFF component to have a transmission curve with a spectral loss profile corresponding to a target loss profile for the optical amplifier; manufacturing the first GFF component; determining the error function of the first GFF component; designing a second GFF component to have a transmission curve with a spectral loss profile corresponding to the error function of the first GFF component (unpackaged or as packaged with other components of the GFF apparatus and/or other components of a gain-flattened optical amplifier); manufacturing the second GFF component; and combining the first and second GFF components.

The present invention relates to certain improved gain-flattening apparatus, including gain-flattening apparatus suitable for use in optical systems, such as telecommunication systems or other systems employing optical signals, and to improved methods of producing and using gain-flattening apparatus, and to gain-flattened amplifiers incorporating such gain-flattening apparatus.

### BACKGROUND

Optical signal systems wherein multiple signal channels are carried by optical fibers over extended distances are known to employ optical amplifiers to batch-amplify all of the signal channels simultaneously. Commercially employed optical amplifiers typically provide an uneven level of gain across their optical wavelength range, e.g., erbium-doped fiber amplifiers (EDFAs) operating in the C-band (generally 1525 nm to 1575 nm) produce a well known two-peaked spectral gain profile. In a typical telecommunication optical system, for example, the gain spectrum or modulation depth of an EDFA, also referred to as the insertion loss variation, gain profile, etc., can range up to 15 dB and beyond. This is generally undesirable, as flat gain characteristics, i.e., level signal strength across the operating bandwidth of the system, typically are important in multiplexed optical systems for increased transmission distance, reduced signal-to-noise ratios and other non-linear effects, or to meet other operating requirements of the system. It is known, therefore, to employ gain-flattened amplifiers, such as gain-flattened optical fiber amplifiers or other gain-flattened optical amplifiers. Gain-flattened amplifiers may be constructed using either active elements or passive elements to flatten the gain, i.e., to provide gain equalization, also referred to as optical equalization or gain compensation, etc. Optical fiber gratings and dielectric thin-film filters, for example, are well known and used commercially for gain-flattening.

It is known, for example to employ a dielectric thin-film gain-flattening filter with an optical amplifier, e.g., an EDFA or other optical fiber amplifier to construct a gain-flattened amplifier. Thin-film gain-flattening filters have advantageous properties, including low insertion loss, small size, economical design and manufacturing costs, acceptable environmental stability, etc. Dielectric thin-film filters are known to have maximum peak loss of about 6 dB (with acceptable quality for typical applications such as telecommunications, e.g., acceptably low PPEF, discussed further, below) under the current state of the art for their design and manufacture. See Recent Advances in Thin Film Filters, Robert B. Sargent. In published U.S. patent application 2003/0179997 A1 of Hwang et al., which is incorporated herein by reference in its entirety for all purposes, it is suggested to employ multiple thin-film gain-flattening filters together in series where the optical amplifier requires a peak loss exceeding the maximum peak loss of one filter, e.g., two 5 dB filters in series to provide a total gain correction of 10 dB. In the operative wavelength band of the amplifier, the thin-film gain-flattening filter is designed to have a transmission curve showing an attenuation profile, also referred to as loss curve, loss profile, peak loss, etc. corresponding to the gain profile of the amplifier. That is, the gain-flattening filter is designed to have a spectral response matching or tracking the inverse of the amplifier's gain profile. As a result, the spectrum of optical signals passing through both the amplifier and the gain-flattening filter in combination achieve even amplification, i.e., nearly flat gain.

Typically, the optical amplifier producer or optical system designer specifies the desired attenuation curve, commonly referred to as the target loss profile, for a gain-flattening device to be used with an optical amplifier. The gain-flattening device producer designs the filter to have a transmission curve matching the target loss profile as nearly as is reasonably possible. Design limitations may result in the theoretical transmission curve of the gain-flattening differing somewhat from the target curve. In addition, the actual transmission curve of the gain-flattening device may differ slightly from its theoretical transmission curve, due to the effect of manufacturing tolerances, e.g., in the case of thin-film filters, natural variations in the characteristics of the thin-films deposited to form the filter, minute substrate irregularities, etc. Thus, the actual transmission curve of the gain-flattening filter or other device will always or almost always differ slightly from the target curve. The difference, the magnitude of which, measured typically in decibels or percentage, generally varies from one wavelength to another across the span of the transmission curve, is referred to as the insertion loss error function of the gain-flattening device, or simply its error function. The combined magnitude of the highest peak of the error function (i.e., the magnitude of the difference between the target curve and the actual transmission curve at the wavelength where the amplification gain was most under-corrected) plus the magnitude of the deepest dip or valley of the error function (i.e., the magnitude of the difference between the target curve and the actual transmission curve at the wavelength where the amplification gain was most over-corrected) is the peak-to-peak error function or PPEF. The purchaser of gain-flattening apparatus typically specifies a maximum permissible PPEF.

The error functions of gain-flattening filters and other gain-flattening devices are somewhat dependent on the desired attenuation profile, and thin-film gain-flattening devices such as filters show larger error functions as the attenuation profile or modulation depth becomes larger or more complex. Typically, the PPEF is approximately 10% of the modulation depth. Thus, for example, if one or more thin-film gain-flattening filters are used to correct 6 dB of modulation depth, the PPEF can be expected to be about 0.6 dB, and correcting 12 dB of modulation depth will result in a PPEF of about 1.2 dB. In this regard it is a problem that if multiple thin-film gain-flattening filters are used in series, such as suggested by Hwang et al. cited above, for example, two thin-film gain-flattening filters each correcting 6 dB of modulation depth for a total gain compensation of 12 dB, the error function and PPEF tend to accumulate. The error function tends to accumulate because thin-film gain-flattening filters typically have systematic error functions. That is, the gain correction error as a function of wavelength will be similar or even nearly identical from one thin-film gain-flattening filter to the next, especially in the typical case of using multiple filters designed to the same target loss profile and/or manufactured in the same batch, i.e., from the same wafer. Significant cost savings are realized by using two essentially identical filters produced from the same wafer. A stack of thin-films is deposited in sequence onto the surface of a large wafer that is transparent in the wavelength band of interest, resulting in nearly uniform filter properties across the wafer surface. The wafer is then diced into small pieces, e.g., 1.0 mm by 1.0 mm up to 2.0 mm by 2.0 mm. The chips can then be packaged in a suitable housing, optionally together with other components for the gain-flattening filter apparatus and/or gain-flattened amplifier, such as, e.g., collimating lenses, isolators, ferrules, monitor ports, taps or mux/demux components for adding or dropping channels, supervisory channels, etc. As a result, however, thin-film gain-flattening filters from the same batch have not only the same transmission curve, i.e., the same or similar gain correction performance, but also the same or similar error function. That is the gain correction error as a function of wavelength will be nearly identical from one component to the next as a consequence of their batch manufacturing process. Consequently, cascading gain-flattening filters having such systematic errors, either by packaging multiple filters into a common housing or positioning multiple discrete gain-flattening filters in series along an optical fiber path, will cause an accumulation of error. See Gain-flattening of High-Performance Optical Amplifiers, Arkell W. Farr, Teraxion Inc. (Cap-Rouge, Canada) (http://www.teraxion.com/en/pdf/articles/Lightwave%20Europe%20Article_GAIN-FLATTENING CURVE.pdf). Similar error function concerns are raised with other gain-flattening devices.

It is an object of the present invention to provide improved gain-flattening apparatus and methods. It is another object to provide improved methods of designing and producing gain-flattening apparatus. Additional objects and advantages of the present invention will be apparent from the following disclosure of the invention and from the detailed description of certain exemplary embodiments.

### SUMMARY

In accordance with one aspect, gain-flattening apparatus for compensation of the spectral gain profile of an optical amplifier for signals in a wavelength band, comprising:
a. a first GFF component having a transmission curve with a spectral loss profile corresponding to a spectral gain profile of the amplifier in the wavelength range, and
b. a second GFF component having a transmission curve with a spectral loss profile corresponding to the error function of the first GFF component.

In accordance with various embodiments of the gain-flattening apparatus disclosed here, the first and second GFF components may comprise any suitable gain-flattening device, e.g., thin-film gain-flattening filters, fiber bragg gratings, etc., and/or any combination thereof.

In accordance with another aspect, a gain-flattened optical amplifier comprises:
a. an optical signal amplifier operative to receive, amplify and output optical signals in an optical wavelength range, wherein the optical amplifier has a spectral gain profile; and
b. gain-flattening apparatus for compensation of the spectral gain profile of the optical amplifier for signals in the optical wavelength range, comprising:
   i) a first GFF component having a transmission curve with a spectral loss profile corresponding to the spectral gain profile of the optical signal amplifier in the wavelength range, and
   ii) a second GFF component having a transmission curve with a spectral loss profile corresponding to the error function of the first GFF component.

The amplifier may be a one-stage or a multi-stage amplifier, and the components of the amplifier may be packaged together with the components of the GFF apparatus or separately. Further, the amplifier may be packaged in one housing or package or in multiple packages, e.g., a pre-amplifier in one housing and a boost amplifier in a second housing, for convenience of manufacture or use, to facilitate access to the signals between the different stages of the amplifier or for other reason. If packaged in multiple housings, any or all of the components or sub-components of the GFF apparatus may be packaged in any one or more of such amplifier packages or may be packaged separately in their own housing(s). It will be understood that packaging of such components and devices typically will employ a housing, similar, for example, to the packaging of other fiber optics devices, e.g., commercial DWDM filters, etc.

In accordance with another aspect, a gain-flattening filter for in-line compensation of the spectral gain profile of an optical amplifier comprises a first GFF component comprising at least one thin-film filter having a transmission curve with a spectral loss profile corresponding to the spectral gain profile of an optical amplifier, and a second GFF component comprising at least one thin-film filter having a transmission curve with a spectral loss profile corresponding to the error function of the first GFF component. In accordance with certain exemplary embodiments of the gain-flattening filters disclosed here, the net insertion loss error function (PPEF) of the first GFF component and second GFF component combined is less than 0.3 dB. In certain exemplary embodiments the PPEF can be as low as 0.2 dB, or even lower.

As noted above, it previously was known to use gain-flattening filters employing multiple filters, wherein the same filter design was used for each of the multiple filters, in order to provide a magnitude of gain correction beyond the practical limit of a single thin-film filter. This resulted in accumulation, i.e., increase, of error function. In the gain-flattening filters disclosed here, according to this first aspect of the present disclosure, error function is not increased by the second GFF component but rather is decreased because the second GFF component has a transmission curve with a spectral loss profile corresponding to the error function of the first GFF component. Thus, the net PPEF of the first and second GFF components combined is less than the PPEF of the first GFF component alone.

It should be understood that the first and second GFF components may be positioned in any order relative to each other. That is, either may be positioned upstream of the other, where upstream means the direction along the optical signal path from which the processed signals are received. Likewise, the first and second GFF components may be used with single or multi-stage optical amplifiers and may be used as end filters, midway filters, etc., and in any combination thereof. The first GFF component may also be referred to here and in the appended claims as the primary GFF component or as the gross GFF component. The second GFF component may also be referred to here and in the appended claims as the “tweak” GFF component or as the correction GFF component. The first and second GFF components and any other components, e.g., lenses, ferrules, etc., necessary or useful for packaging the gain-flattening filter or for connection into the optical pathway or the like, may be housed in a single housing as a single device or may be housed in multiple housings. However, the first and second GFF components preferably are used in immediate optical combination, that term being defined here to mean that the second GFF component is used in optical proximity to the first GFF component in the optical pathway carrying the optical signals being amplified and gain-flattened, such that the spectral loss profile of the second GFF component corresponds to the error function of the first GFF component unaltered by intermediate optical components other than components of the optical amplifier and the aforesaid components of the gain-flattening filter.

In accordance with certain exemplary embodiments of the GFF apparatus disclosed here, the second GFF component has only a single gain-flattening filter. Since the error function is generally proportional to the peak loss, in typical embodiments of the GFF apparatus disclosed here the net PPEF will be advantageously lower where the second GFF component having a loss profile corresponding to the error function of the first GFF component, is designed to correct much less modulation depth than the first GFF component. Preferably, especially in exemplary embodiments providing at least 6 dB total gain compensation, the first GFF component provides at least 5 dB of gain compensation or modulation depth and the second GFF component provides less than 2 dB of gain compensation, and less than 1.5 dB in certain embodiments. Accordingly, only a single gain-flattening filter is used for the second GFF component in certain preferred embodiments, because its low peak loss requirement is well within the commercially practical range of peak loss for a single gain-flattening filter (currently about 6 dB). Thus, multiple gain-flattening filters are typically unnecessary for the second GFF component and multiple gain-flattening filters would require additional manufacturing and packaging and in some cases additional auxiliary components, etc., resulting in added weight, complexity, insertion loss and cost. In accordance with certain exemplary embodiments of the gain-flattening filters disclosed here, for use with EDFAs in the C-band, the net insertion loss error function (PPEF) in the C-band of the first GFF component and second GFF component combined is less than 0.3 dB. In certain exemplary embodiments the PPEF can be as low as 0.2 dB or even lower.

In accordance with another aspect, a gain-flattening filter apparatus for in-line compensation of the spectral gain profile of an EDFA for signals in the C-band, comprises a first GFF component comprising at least one thin-film filter and having a transmission curve in the C-band with a spectral loss profile corresponding to an EDFA spectral gain profile in the C-band, and a second GFF component comprising at least one thin-film filter and having a transmission curve in the C-band with a spectral loss profile corresponding to the error function of the first GFF component. In accordance with certain exemplary embodiments, the peak loss of the first GFF component is at least 5 dB and the peak loss of the second GFF component is less than 2 dB, or even less than 1.5 dB. In accordance with certain exemplary embodiments of the gain-flattening filter apparatus according to this or other aspects of the present disclosure, the peak loss of the first GFF component and second GFF component combined is at least 8 dB.

In accordance with another aspect, a gain-flattening filter apparatus for in-line compensation of the spectral gain profile of an optical amplifier comprises: a first GFF component comprising at least one thin-film filter, and a second GFF component comprising at least one thin-film filter, wherein the peak loss of the first GFF component is at least three times the peak loss of the second GFF component. In accordance with certain exemplary embodiments of such gain-flattening filter apparatus, the peak loss of the first GFF component is at least four or more times the peak loss of the second GFF component.

In accordance with another aspect, a gain-flattening filter apparatus for compensation, i.e., correction of the spectral gain profile of an optical amplifier comprises a first GFF component and a second GFF component, wherein the peak loss of the first GFF component is at least 5 dB and the peak loss of the second GFF component is less than 2 dB, or even less than 1.5 dB. In accordance with certain exemplary embodiments, the peak loss of the first GFF component may be greater than 5 dB. In accordance with certain exemplary embodiments wherein the first GFF component is a single thin-film filter, for example, its peak loss may be any value that can be produced with adequate quality (PPEF, etc.) by the then current state of the art.

In accordance with another aspect, a gain-flattening filter apparatus for in-line compensation of the spectral gain profile of an optical amplifier over a range of optical signal wavelengths, comprises:
a. a first GFF component comprising at least one thin-film filter, and designed to have a transmission curve with a spectral loss profile matching a target loss profile corresponding to the spectral gain profile of the optical amplifier over said range of signal wavelengths, and
b. a second GFF component comprising at least one thin-film filter, and designed to have a transmission curve with a spectral loss profile corresponding to the error function of the first GFF component, where the error function is the measured difference between the actual spectral loss profile of the first GFF component and the target loss profile. In accordance with certain exemplary embodiments of the gain-flattening filters of this and other aspects of the present disclosure, the peak loss over the range of optical signal wavelengths of the first GFF component and second GFF component combined is at least 8 dB. In accordance with certain exemplary embodiments of the gain-flattening filters of this and other aspects of the present disclosure, the net insertion loss error function (PPEF) over the range of optical signal wavelengths is less than 0.3 dB or in certain preferred embodiments less than 0.2 dB, for the first GFF component and second GFF component combined. In accordance with certain exemplary embodiments of the gain-flattening filters of this and other aspects of the present disclosure, the peak loss of the first GFF component over the range of optical signal wavelengths is at least three times, or even four times or more, the peak loss of the second GFF component over the range of optical signal wavelengths. In accordance with certain exemplary embodiments of the gain-flattening filters of this and other aspects of the present disclosure, the peak loss of the first GFF component over the range of optical signal wavelengths is at least 5 dB and the peak loss of the second GFF component over the range of optical signal wavelengths is less than 2 dB.

In accordance with another aspect, a gain-flattened optical amplifier comprises:
a. at least one optical amplifier operative to receive, amplify and output optical signals in an optical signal wavelength range, wherein the optical signal amplifier has a spectral gain profile; and
b. a gain-flattening filter for in-line compensation of the spectral gain profile of the at least one optical amplifier for signals in the optical signal wavelength range, comprising:
   i. a first GFF component comprising at least one thin-film filter and having a transmission curve in the optical signal wavelength range with a spectral loss profile corresponding to the spectral gain profile of the optical signal amplifier, and
   ii. a second GFF component comprising at least one thin-film filter and having a transmission curve in the optical signal wavelength range with a spectral loss profile corresponding to the error function of the first GFF component.

In accordance with certain exemplary embodiments of the gain-flattened optical signal amplifiers disclosed here, the optical signal amplifier is, e.g., one or more optical fiber amplifiers, one or more Raman amplifiers, one or more semiconductor optical amplifiers (SOAs) or any combination thereof. In accordance with certain exemplary embodiments of the gain-flattened optical signal amplifiers disclosed here, the optical signal amplifier is an optical fiber amplifier such as, e.g., an erbium-doped optical fiber amplifier where the optical signal wavelength range is the C-band or, alternatively, a doped optical fiber amplifier where the optical signal wavelength range is the L-band, or a doped optical fiber amplifier where the optical signal wavelength range is the S-band. Also, GFF apparatus in accordance with certain exemplary embodiments can be adapted for use with optical amplifiers operative in any combination of such bands and/or other wavelength ranges.

In accordance with a method aspect, a gain-flattening filter is produced for a particular application, e.g., for use with a particular optical amplifier for which the customer has provided the gain-flattening filter manufacturer a target loss profile. The first GFF component, having one or more gain-flattening filters depending at least on the magnitude of the modulation depth, i.e., of the total peak loss needed to flatten the gain provided by the optical amplifier, is designed to have a transmission curve with a spectral loss profile corresponding to the gain profile of the optical amplifier. That is, it is designed to have a transmission curve matching the target loss curve as closely as is commercially practicable. The first GFF component is then manufactured and its error function determined by testing the difference between the spectral loss profile of its actual transmission curve and the target loss profile. The second GFF component is then designed to have a transmission curve with a spectral loss profile corresponding not to the target loss profile but rather to the error function of the first GFF component. The second GFF component is then manufactured and combined with the first GFF component. First and second GFF components may be combined, for example, by identifying well matched units for use together or, in certain exemplary embodiments by assembly together, e.g., in a common housing.

### BRIEF DESCRIPTION OF THE DRAWINGS

FIG. 1 is a schematic section view of a gain flattening filter in accordance with an exemplary embodiment of the present invention.

FIG. 2 is a schematic section view of a first or second GFF component of GFF apparatus in accordance with an exemplary embodiment of the present invention, for in-line compensation of the spectral gain profile of an EDFA for signals in the C-band.

FIG. 3 is a schematic diagram of a gain-flattened optical amplifier in accordance with an exemplary embodiment of the present invention.

FIGS. 4-8 are graphs relating to the performance of a gain-flattened optical amplifier in accordance with one exemplary embodiment of the present invention

### DETAILED DESCRIPTION OF CERTAIN EXEMPLARY EMBODIMENTS

The following discussion of certain exemplary embodiments of the invention focuses on gain-flattening apparatus used in multiplexed optical signal systems, such as telecommunication systems and the like. GFF apparatus, gain-flattened optical amplifiers employing them, their design and production, and methods of the present invention, however, are applicable generally to optical systems. In certain of the embodiments disclosed here, for convenience of discussion, the gain-flattening apparatus employs thin-film filters. In certain of the embodiments disclosed here, for convenience of discussion, the gain-flattening apparatus are designed for dense wavelength division multiplexed telecommunications systems operating in the C-band and employing EDFA amplifiers. However, it will be readily apparent to those skilled in the art, that the GFF apparatus, gain-flattened optical amplifiers employing them and the design and production methods in accordance with the principles disclosed here have application within the scope of the invention to other systems, including telecommunications systems operating in other wavelength bands and using other amplifiers, and to other optical systems calling for gain compensation. It should be understood that the use of a singular indefinite or definite article (e.g., “a,” “an,” “the,” etc.) in this disclosure and in the following claims follows the traditional approach of meaning “at least one” unless in a particular instance it is clear from context that the term is intended in that particular instance to denote one and only one.

In certain exemplary embodiments suitable for use in the C-band with EDFA amplifiers, the one or more gain-flattening devices, e.g., thin-film dielectric gain-flattening filters, fiber bragg gratings or other gain-flattening devices of the first GFF component, i.e., the primary or gross GFF component, each has a spectral response or transmission curve which corresponds to the non-uniform gain spectrum of an EDFA in the C-band. Thus, the spectral response across the C-band for each gain-flattening filter or other device of the first GFF component in such embodiments will be a transmission curve having what may be said generally to be a two-valley configuration, the approximate inverse of the well-known two-peak configuration of the EDFA gain curve for amplified optical signals across the C-band. Alternative embodiments are suitable for use with a doped optical fiber amplifier for optical signals in the L-band. In such embodiments the gain-flattening filter(s) of the gross GFF component of the GFF apparatus is designed and produced with a transmission curve corresponding to, i.e., having a spectral profile generally following the inverse of, the gain profile of doped optical fiber amplifiers. Alternative embodiments are suitable for use with an doped optical fiber amplifier for optical signals in the S-band. In such embodiments the gain-flattening filter(s) of the gross GFF component of the GFF apparatus is designed and produced with a transmission curve corresponding to the gain profile of doped optical fiber amplifiers. As noted above, the amplifier manufacturer or the optical system designer typically will provide the precise target loss profile to be matched by the GFF apparatus.

In certain exemplary embodiments of the GFF apparatus disclosed here, the transmission curve of the gross gain-flattening component corresponds to the gain spectrum of an EDFA and provides compensation of at least about 5 dB, and in certain embodiments at least 6 dB, and in certain embodiments at least 8 dB or more. Recognizing that the error function tends to increase with the modulation depth, the low error function achieved by well designed and well manufactured embodiments of the GFF apparatus disclosed here, comprising first and second GFF components, is especially advantageous for applications requiring at least 8 dB of gain correction. As disclosed above, low net insertion loss error function is achieved by the GFF apparatus disclosed here at least in part due to the second GFF component, i.e., the correction or tweak component, having a transmission curve corresponding to the error function of the first GFF component. While it is desirable that the first GFF component be operative to correct 100% of the gain unevenness in the signals passing through the amplifier(s), as noted above this is typically not achieved. Typically, the first GFF component is operative to provide correction of at least 75%, and often at least about 80% or even 90% or more of the pre-gain-flattened modulation depth of the amplified optical signals. The second GFF component provides additional correction but, as noted above, has a transmission curve corresponding to the error function of the first GFF component and yields a smaller net error function and PPEF for the two components combined. It should also be recognized that certain exemplary embodiments optionally may comprise additional GFF components providing additional gain correction and/or other functionality.

In certain preferred embodiments, the second GFF component provides less than 2 dB of gain correction, and in certain preferred embodiments less than 1.5 dB of gain correction. As noted above, a gain-flattening filter component having one or more thin-film dielectric gain-flattening filters well designed and produced to have a transmission curve matching a target loss profile to provide gain-flattening for an EDFA may have a PPEF of approximately 10% of the gain correction, generally due to routine thin-film design and production limitations and inaccuracies. However, GFF apparatus in accordance with the present disclosure, employing a thin-film dielectric gain-flattening filter or fiber bragg grating or other gain correcting device as a secondary or correction or “tweak” GFF component that has a transmission curve which corresponds to the error function of the primary GFF component, rather than to the original target loss profile for the amplifier, and which has a smaller loss profile than the first GFF component, can be effective to provide final gain correction with a net insertion loss error function lower than the insertion loss error function of the first GFF component alone. In preferred embodiments wherein the second GFF component provides less than 2 dB of gain correction, the GFF apparatus can yield gain correction with perhaps only 0.4 dB PPEF or even less than 0.3 dB, and in preferred embodiments comprising well designed and produced components, as little as 0.2 dB or even less. In certain embodiments, for example, the modulation depth of EDFA amplified optical signals in a telecommunications system operating in the C-band can be reduced to less than 0.4 dB, in some preferred embodiments to less than 0.3 dB or even 0.25 db or less, e.g., to 0.2 or less.

Typically only one filter or fiber gragg grating, etc. is needed in the tweak GFF component. In typical embodiments of the gain-flattened EDFAs disclosed here, the transmission curve of a gain-flattening filter employed in the tweak component provides compensation of not more than about 2 dB of the pre-gain-flattened modulation depth of the amplified optical signal. This is well within the gain compensation range of a single thin-film filter or single fiber gragg grating employed for the second GFF component of the GFF apparatus. As noted above, even with a 10% error function, because the gain correction provided by the tweak gain-flattening device is small and because it corresponds to the residual non-uniformity of gain left by the gain-flattening filter, fiber gragg grating or other device of the first GFF component, the combined gain correction provided by the gross and tweak components of the GFF apparatus is significantly improved over gain-flattening apparatus using only one or more gain-flattening devices designed to have transmission curves corresponding to the target loss profile of the amplifier.

It should be recognized, that correspondence of the spectral loss profile of the GFF apparatus disclosed here to a target loss profile does not exclude the possibility that the actual spectral loss profile of the GFF apparatus, as packaged, may differ somewhat from the spectral loss profile of the GFF apparatus alone. Connectors, packaging and the like, even passive components packaged with the filter, such as ferrules, lenses, etc. may slightly impact the actual spectral loss profile of the GFF apparatus in the field, i.e., in actual use in an optical system, such as a telecommunications system or other optical signal system. Whether or not such effects are taken into account in the design of any particular embodiment of the GFF apparatus disclosed here will depend on the circumstances of that particular embodiment.

In accordance with certain exemplary embodiments, where an optical amplifier requires a peak loss exceeding the practical limit of a single thin-film filter or other gain-flattening device to be used in a particular embodiment (e.g., exceeds the gain loss that can be achieved using then available and commercially reasonable techniques and materials, etc.), a plurality of devices can be used as the first GFF component of the GFF apparatus, such as any combination of thin-film filter(s), fiber bragg grating(s) and/or other devices designed to the target loss profile. For example, where the modulation depth exceeds the gain equalization capacity of commercially practical thin-film gain-flattening filters, multiple thin-film gain-flattening filters are used in series to correct, i.e., flatten, the gain of the optical amplifier. In certain exemplary embodiments the total gain correction of the first GFF component is equally divided between or among the multiple gain flattening filters of the first GFF component. In certain embodiments, for example, the gain flattening filters of the first GFF component are all from the same manufacturing batch, e.g., from the same wafer. Multiple thin-film gain-flattening filters of the first GFF component can be packaged in a common housing or in separate housings. Similarly, the gain-flattening filter of the second or tweak GFF component can be packaged together with or separately from the gain-flattening filter(s) of the first GFF component.

In accordance with certain exemplary embodiments employing a plurality devices, e.g., a plurality of thin-film filters and/or fiber bragg gratings, etc. in the first GFF component, especially but not necessarily only where an optical amplifier requires a peak loss exceeding the practical limit of a single such device, e.g., of a single thin-film filter, at least a first such filter or other device is designed to the target loss profile and at least one additional such filter or other device of the first GFF component is designed to the original target loss profile adjusted for the measured error function of the first such device. Ihe first and then additional gain-flattening devices of the first GFF component of such embodiments would in such embodiments be manufactured sequentially rather than in the same batch. Such first and additional devices preferably each has a peak loss of at least about 5 dB and each provides gain correction equal to at least three times or even four times or more the gain correction provided by the tweak GFF component of the apparatus. Such embodiments may be especially suitable, for example, where thin-film filters are employed and the thin-film design technology available at the time does not permit the transmission curve of the first filter to be designed to follow the target loss profile provided by the system designer or amplifier manufacturer with acceptable precision over the entire wavelength range of interest.

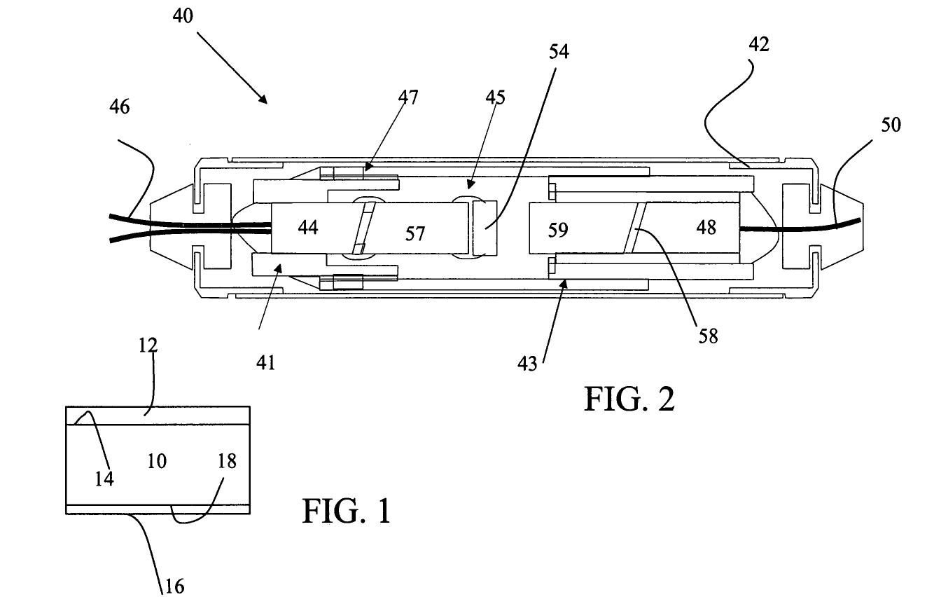

Thin-film filters employed in certain exemplary embodiments of the GFF apparatus disclosed here for gain compensation, e.g., with an EDFA or other optical amplifier, can be designed and manufactured in accordance with any technology, equipment and techniques now known or known in the future, that are suitable for producing filters having a transmission curve with a loss profile sufficiently accurately corresponding to the gain profile of the optical amplifier (in the case of gain-flattening filters for a first GFF component of the apparatus) or to the error function of the first GFF component (in the case of gain-flattening filters for a second GFF component of the apparatus). Suitable filters can be designed in accordance with current techniques, e.g., using commercially available software, such as Essential Macleod software, a comprehensive software package for the design and analysis of optical thin films, or TFCa1c from Software Spectra Inc., etc. Suitable filters can be manufactured in accordance with various currently known techniques, such as sputtering evaporation or ion-assisted evaporation coating techniques, etc. A suitable construction for gain-flattening filters for the first and/or second GFF components is shown in FIG. 1, wherein a transparent substrate 10 is formed of any suitable material that is transparent in the wavelength band of interest, e.g., substrate wafers commercially used for production of DWDM filters. Numerous suitable materials are commercially available and will be readily apparent to those skilled in the art, given the benefit of this disclosure. Coating 12 on first surface 14 of substrate 10 has a transmission curve corresponding to the target loss profile of an optical amplifier and is formed of a series of thin-film layers. The gain-flattening filter further comprises an AR (anti-reflection) coating 16 on a second surface 18 of the substrate 10. The GFF coating 12 and the AR coating can be deposited by sputter coating or any suitable alternative technique, such as those mentioned above. Likewise, fiber bragg gratings can be manufactured with materials and techniques currently known and used or with suitable materials and techniques developed in the future.

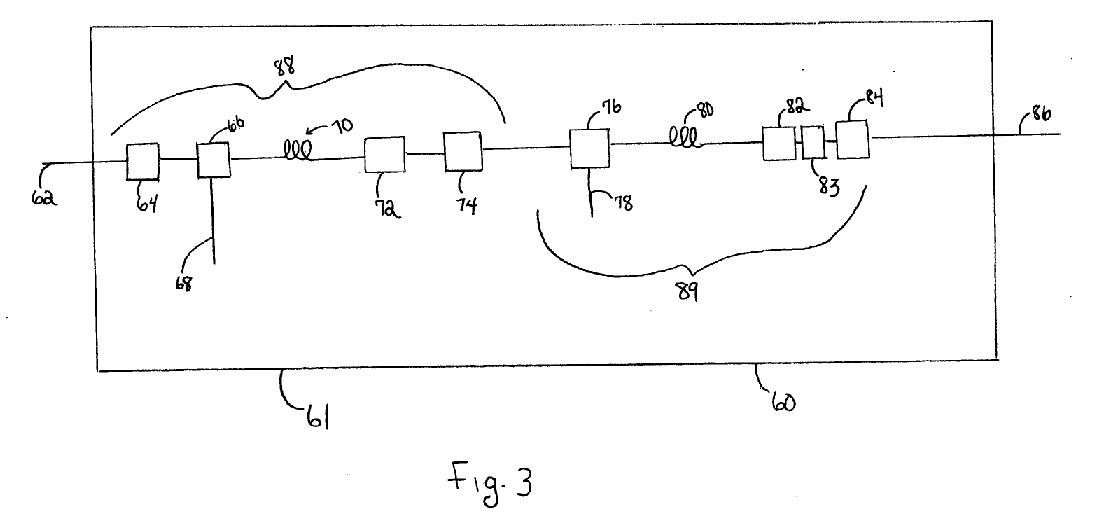

Referring now to FIG. 2, GFF component 40 is one embodiment of a first GFF component for GFF apparatus in accordance with the present invention. This embodiment is suitable for use with a separately packaged second (i.e., tweak) GFF component, and it will be understood by those skilled in the art, given the benefit of this disclosure, that the same package design can be used for such second GFF component. Together, such first and second GFF components are suitable, for example, for in-line compensation of the spectral gain profile of an EDFA for signals in the C-band. GFF component 40 comprises a housing 42 in which is housed a first ferrule 44 providing an input optical fiber 46 for carrying optical signals into the housing, and a second ferrule 48 disposed in the housing at the opposite end and providing an output optical fiber 50 for carrying optical signals out of the housing. Housed in the housing between the first and second ferrules is a gain-flattening filter 54 mounted between GRIN lens 57 and GRIN lens 59. Gain-flattening filter 54 has a transmission curve corresponding to the gain profile of an EDFA or other optical amplifier. In alternative embodiments, one or more additional gain-flattening filters can be mounted in the housing in series with filter 54. As noted above, in alternative embodiments the filter can be a tweak filter having a transmission curve corresponding to the error function of a first GFF component. Where component 40 is a first GFF component, filter 54 having a transmission curve corresponding to the gain profile of an optical amplifier, it would be used together with a separately packaged second GFF component. Mounting components in housing 42 include gold-plated stainless steel fixtures 41 and 43, epoxy blobs 45 and solder 47. (Only representative epoxy blobs and solder are labeled.)

It will be recognized by those skilled in the art, given the benefit of this disclosure, that alternative and/or additional components may be employed in the GFF apparatus disclosed here and in the gain-flattened amplifiers disclosed here comprising such GFF apparatus. Alternative and additional components include those presently known and thos developed over time in the future. Multiple ferrule designs are known, for example, and it will be within the ability ofd those skilled in the art to select and employ suitable ferrules, if any, in various different embodiments of the GFF apparatus and gain-flattened amplifiers disclosed here. Likewise, multiple alternative designs are known for collimating lenses and other lenses which may be used, including ball lenses, GRIN lenses, barrel lenses, etc. Thus, for example, ball lenses and/or collimating lenses may be used in place of the GRIN lenses of the embodiment shown in FIG. 2.

In accordance with a method aspect of the present invention, gain-flattening filter apparatus for use with an optical amplifier is designed and manufactured to have a transmission curve, corresponding to the gain profile of EDFAs or other optical amplifiers. More specifically, gain-flattening filters are differently designed and produced for a first or gross GFF component and a second or tweak GFF component, in accordance with principles set forth above. In accordance with certain exemplary embodiments the method comprises designing a first GFF component to have a transmission curve with a spectral loss profile corresponding to a target loss profile for an optical amplifier. The one or more gain-flattening filters of such first GFF component are manufactured and the error function of the first GFF component (optionally, as packaged for use in the field) are determined, e.g., by direct measurement of each unit in a batch or by measurement of a representative quantity of units. The gain-flattening filter(s) of the second GFF component is then designed to have a transmission curve with a spectral loss profile corresponding to the error function of the first GFF component, and then manufactured. The first and second GFF components are then combined. Optionally they are packaged together in a common housing. Alternatively, gain-flattening filters for the first and second GFF components are identified for use together in a GFF apparatus based on their measured transmission curves.

In accordance with certain exemplary embodiments of gain-flattened optical amplifiers constructed in accordance with the principles disclosed here:
a) the amplifier is a multi-stage amplifier, and
b) the first GFF component comprises
   i) a first GFF subcomponent having a transmission curve with a spectral loss profile corresponding to the spectral gain profile of the pre-amplification stage of the amplifier in the wavelength range of interest, and
   ii) a second GFF subcomponent having a transmission curve with a spectral loss profile corresponding to the spectral gain profile of the boost amplification stage of the optical signal amplifier in the wavelength range; and
b) the second GFF component has a transmission curve with a spectral loss profile corresponding to the first GFF component, i.e., to the net error function of the first GFF subcomponent and the second GFF subcomponent and, optionally, other components of the gain-flattened optical amplifier. It should be understood that the transmission curve of the second or tweak GFF component corresponds to the error function of the first GFF component if it corresponds to the error function of the unpackaged first GFF component or to the error function of the first GFF component as packaged and, optionally, taking into effect any impact of other components of the GFF apparatus. Similarly, in gain-flattened amplifiers according to certain exemplary embodiments of the present disclosure, the transmission curve of the second or tweak GFF component may correspond to the error function of the first GFF component unpackaged or to the error function of the first GFF component as packaged and, optionally, taking into effect any impact of other components of the gain-flattened amplifier.

The error function of the first GFF component, to serve as the target loss profile for the second GFF component, can be determined by theoretical calculation based on the planned design of the first GFF component. Alternatively (or in addition) the error function of the first GFF component can be determined empirically, such as by actual measurement of the error function of the first GFF component. In embodiments employing empirical determination of the error function, it can be determined on a unit-by-unit basis, lot-by-lot basis or both. The error function of the first GFF component optionally is determined, whether by theoretical calculation, empirically or both, based on the first GFF component alone or in assembly with other components and/or devices of the GFF apparatus or of the gain-flattened filter, as the case may be, in which it will be employed. Thus, for example, the first GFF component can be produced and assembled (e.g., packaged into a housing) with some or all of the other components or devices to be included therewith, and the error function determined for such assembly. The second GFF component can then be designed and produced to correspond to such error function of the first GFF component in assembly. For optional lot-by-lot determination of the error function, for example, several such first GFF component assemblies can be produced and their error functions (alone or in assembly) measured and averaged or otherwise consolidated to determine the target transmission curve of the second GFF components. Where thin-film filters are used for the first GFF components, for example, several samples of first GFF components can be produced from a batch of filters, e.g., the filters obtained from a wafer. For optional unit-by-unit determination of the error function, for example, the first GFF component can be produced and the error function (alone or in assembly) measured to determine the target transmission curve of the second GFF components. In embodiments employing fiber bragg gratings for the second GFF components, for example, the error function of a first GFF component in assembly with all or some of the other components or devices can be measured and the fiber bragg grating then customized for that unit and produced at that time or later to complete the GFF apparatus.

Referring now to FIG. 3, an optical amplifier 60 in accordance with certain exemplary embodiments of the invention disclosed here is seen to comprise fiber coils, such as erbium-doped fiber coils or the like, for amplification of multiplexed signals, such as multiplexed signals in the C-band, as well as GFF apparatus for gain compensation, housed together in housing 61. Optical fiber 62 carries multiplexed optical signals into housing 61 to an isolator 64. From isolator 64 the optical signal travel to multiplexing (mux) device 66 which also receives pumped optical input from a suitable source (not shown) via optical fiber 68 at a suitable wavelength for EDFA amplification, such as about 980 nm or 1480 nm or other suitable wavelengths. The combined optical output is fed to a suitable length of erbium-doped optical fiber packaged in the housing as coils 70, for amplification of the aforesaid multiplexed optical signals. The amplified signals, with uneven gain typical of EDFA amplification, is fed to gain-flattening filter 72 having a transmission curve with a loss profile corresponding to the gain profile of coils 70. The output from filter 72 is fed to isolator 74. It will be understood that filter 72 in alternative embodiments, e.g., where greater gain compensation is required, may be replaced by multiple such filters. Following in series from isolator 74, signals are fed to mux device 76 which receives pumped optical input from a suitable source (not shown) via optical fiber 78 at a suitable wavelength for EDFA amplification. The combined optical output is fed to a suitable length of erbium-doped optical fiber packaged in the housing as coils 80, for further amplification. The amplified signals, having a transmission curve typical of EDFA amplification and residual gain unevenness due to the error function of filter 72, is fed to gain-flattening filter 82. Filter 82 is a gross gain-flattening filter, e.g., having peak loss greater than 5 dB and a transmission curve corresponding to the gain profile of fiber coils 80. It will be understood that filter 82, in alternative embodiments, e.g., where greater gain compensation is required, may be replaced by multiple such filters. From gross filter 82 signals pass to tweak filter 83 having peak loss less than 2 dB and transmission curve corresponding to the combined error function of filters 72 and 82 against the target loss profile for correcting the combined gain unevenness of coils 70 and 80. The output from filter 83 is fed to isolator 84. Multiplexed signals, amplified and gain-flattened by the EDFA and GFF apparatus of amplifier 60, are carried out of housing 61 via optical fiber 86. As noted above, various additional components may be incorporated into gain-corrected amplifier 60.

The optical elements from isolator 64 to isolator 74 may be considered a pre-amplifier or first stage amplifier 88 of gain-corrected amplifier 60. The optical elements from isolator 74 to isolator 84 may be considered a boost or second stage amplifier 89. Optionally, such first and second amplification stages can be packaged separately, i.e., in separate housings. This may be advantageous, for example, in order to allow access between the two stages for auxiliary signal treatment. Such auxiliary signal treatment between stages of a multi-stage optical amplifier can include, for example, dispersion compensation which may be performed by passing the partially amplified signals through a suitable length of dispersion compensation fiber or other suitable device. Auxiliary signal treatment between stages of a multi-stage optical amplifier also can include, for example, mux/de-mux processing to add and/or drop signals, etc. For purposes of the present disclosure, the two amplification stages in this embodiment may be considered to be parts of the same optical amplifier comprising both fiber coils 70 and 80, and correspondingly, gain-flattening filters 72 and 82 collectively may be considered the first GFF component of the GFF apparatus incorporated into the gain-flattened amplifier. Gain-flattening filter 83 may be considered the second GFF component of the GFF apparatus. It will be understood by those skilled in the art that the two filters 72 and 82, even if the loss profile of their respective transmission curves are not identical to one another, could be switched with each other without substantial impact on the total gain correction provided by the GFF apparatus. If the two filters are not identical, switching their positions would be expected to have an impact on gain or other characteristics of the optical signals at the point where they pass from the first stage 88 to second stage 89, i.e., between the two stages, and this would be unwanted in alternative embodiments where the two stages are housed in separate housings so as to provide access between the two stages for signal treatment, as mentioned above.

In other alternative embodiments similar in certain respects to the embodiment illustrated in FIG. 3, a separate tweak filter could be provided for gross filter 72, i.e., a low peak loss filter having a transmission curve with a loss profile in the C-band corresponding to the error function of filter 72 alone. In that case, filter 72 can be considered the first GFF component of a first GFF apparatus of gain-flattened optical amplifier 60, and its associated tweak filter would be the second GFF component of that GFF apparatus. Filters 82 and 83 in that case, with filter 83 having a transmission curve with a loss profile in the C-band corresponding to the error function of filter 82 alone, would be considered the first and second GFF components, respectively, of a second GFF apparatus of amplifier 60. Other alternative arrangements consistent with the principles disclosed here will be apparent to those skilled in the art, given the benefit of this disclosure.

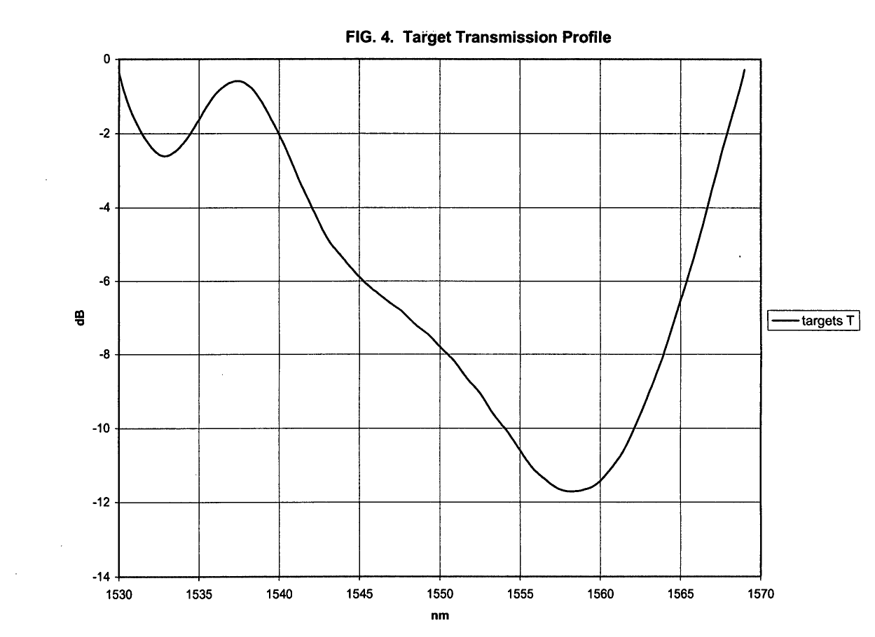

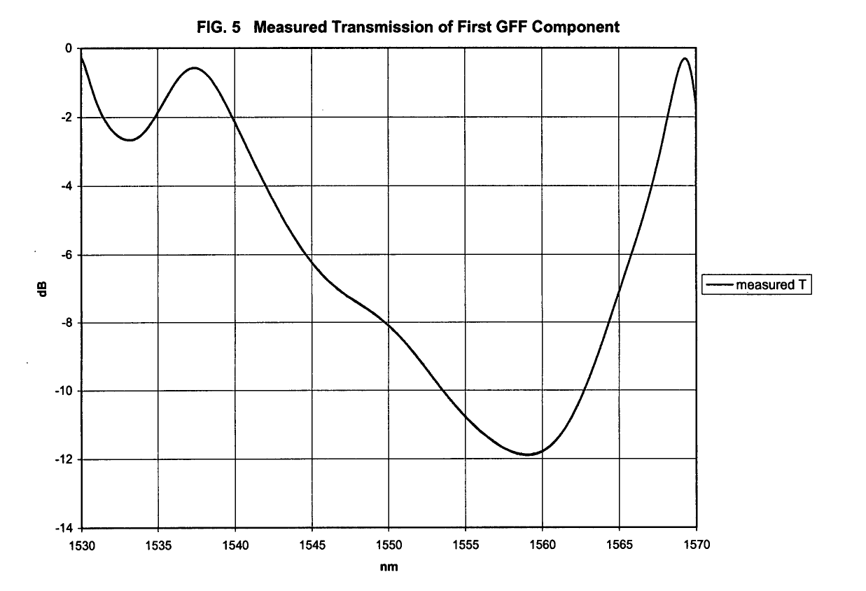

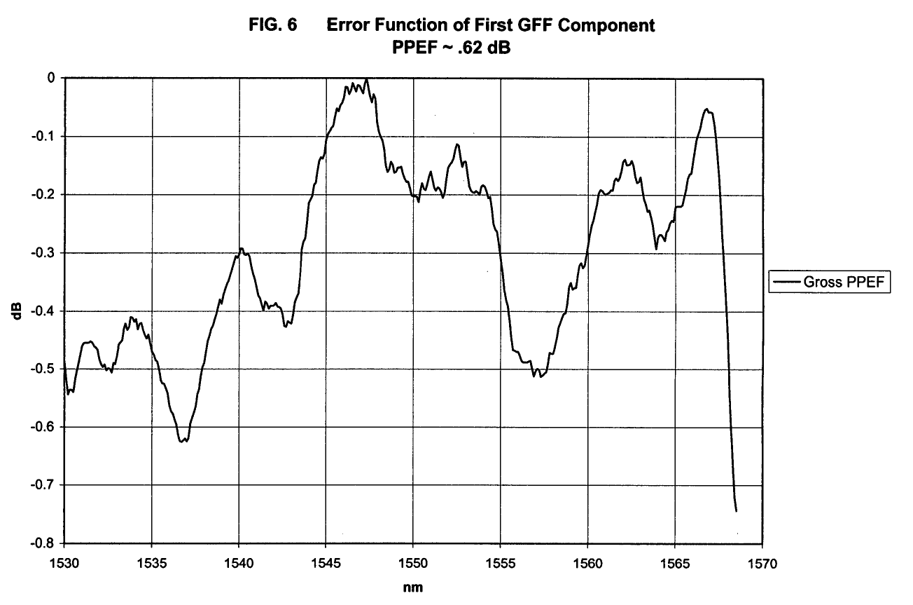

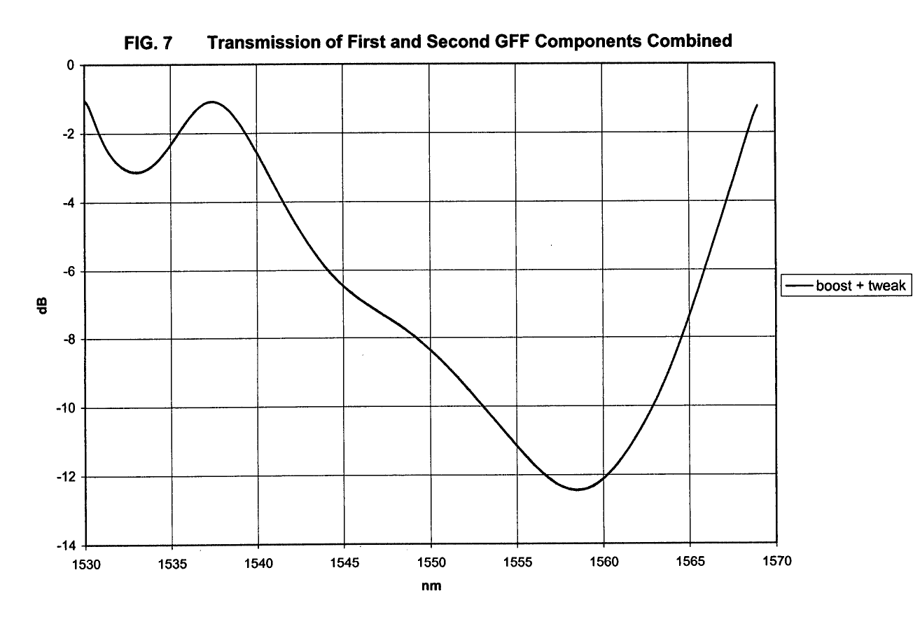

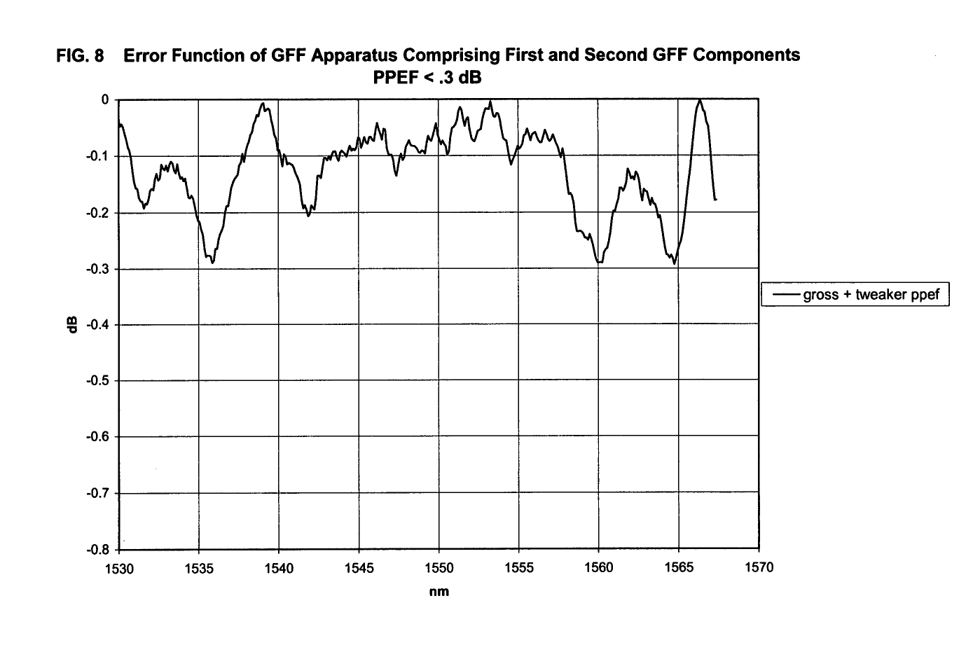

Referring now to FIGS. 4-8, exemplary improvement is illustrated in the error function of gain-flattening apparatus in accordance with the present disclosure, for an optical amplifier for multiplexed signals across a wavelength band, specifically, in the illustrated embodiment, in the C-band used for telecommunication systems. FIG. 4 shows a transmission curve with a target transmission profile (the “target transmission profile,” inverse of the target loss profile), i.e., the transmission curve profile desired for the GFF apparatus. FIG. 5 shows a transmission curve across the same wavelength band for a typical embodiment of a first GFF component designed and produced to yield the desired transmission profile. It can be seen in FIG. 5 that the actual transmission curve measured for such exemplary first GFF component closely tracks the target transmission profile shown in FIG. 4. As would be expected in a typical embodiment, however, the measured transmission curve is not exactly the same as the target transmission curve, and the error function of the first GFF component is shown in FIG. 6. It can be seen there that the PPEF is about 0.62 dB. The second GFF component of this exemplary embodiment, in accordance with the principles disclosed here, is designed to have a transmission curve with a loss profile (and, of course its inverse transmission profile) corresponding to the error function of the first GFF component. As a result, the error function of the GFF apparatus, comprising both the first and second GFF components, is significantly improved over the error function and PPEF of the first GFF component alone. FIG. 8 shows the error function of the GFF apparatus comprising both the first and second GFF components. As can be seen by comparing the error function shown in FIG. 6 for the first GFF component alone to the error function shown in FIG. 8 for the GFF apparatus comprising both the first and second GFF components, the error function is smaller, meaning that the gain is more even for the different multiplexed signals that would be amplified by the gain-flattened optical amplifier across the C-band. Also, the PPEF value is seen to be improved from about 0.62 dB for the first GFF component alone to less than 0.3 dB for the GFF apparatus comprising both the first and second GFF components.

Although the present invention has been described in terms of specific exemplary embodiments, it will be appreciated that various modifications and alterations will be apparent from this disclosure to those skilled in the art, without departing from the spirit and scope of the invention as set forth in the following claims.

1. Gain-flattening apparatus for compensation of the spectral gain profile of an optical amplifier for signals in a wavelength band, comprising:
a a first GFF component having a transmission curve with a spectral loss profile corresponding to a spectral gain profile of the amplifier in the wavelength range, and
b a second GFF component having a transmission curve with a spectral loss profile corresponding to the error function of the first GFF component.

2. The gain-flattening apparatus of claim 1 wherein the first GFF component comprises at least one thin-film filter.

3. The gain-flattening apparatus of claim 1 wherein the first GFF component comprises at least two thin-film filters in series.

4. The gain-flattening apparatus of claim 1 wherein the second GFF component comprises a single thin-film filter.

5. The gain-flattening apparatus of claim 1 wherein the first GFF component comprises at least one fiber bragg grating.

6. The gain-flattening apparatus of claim 1 wherein the first GFF component comprises at least two fiber bragg gratings in series.

7. The gain-flattening apparatus of claim 1 wherein the second GFF component comprises a single fiber bragg grating.

8. The gain-flattening apparatus of claim 1 wherein the optical amplifier comprises a fiber amplifier.

9. The gain-flattening apparatus of claim 7 wherein the fiber amplifier comprises an EDFA.

10. The gain-flattening apparatus of claim 1 wherein the wavelength band lies in the C-band.

11. A gain-flattened optical amplifier comprising:
a. an optical signal amplifier operative to receive, amplify and output optical signals in an optical wavelength range, wherein the optical amplifier has a spectral gain profile; and
b. gain-flattening apparatus for compensation of the spectral gain profile of the optical amplifier for signals in the optical wavelength range, comprising:
i) a first GFF component having a transmission curve with a spectral loss profile corresponding to the spectral gain profile of the optical signal amplifier in the wavelength range, and
ii) a second GFF component having a transmission curve with a spectral loss profile corresponding to the error function of the first GFF component.

12. The gain-flattened optical amplifier of claim 11 wherein the optical amplifier is a multi-stage amplifier.

13. The gain-flattened optical amplifier of claim 11 wherein the optical amplifier comprises a pre-amplification stage and a boost amplification stage.

14. The gain-flattened optical amplifier of claim 12 wherein:
a the first GFF component comprises
i) a first GFF subcomponent having a transmission curve with a spectral loss profile corresponding to the spectral gain profile of the pre-amplification stage of the optical signal amplifier in the wavelength range, and
ii) a second GFF subcomponent having a transmission curve with a spectral loss profile corresponding to the spectral gain profile of the boost amplification stage of the optical signal amplifier in the wavelength range; and
b the second GFF component has a transmission curve with a spectral loss profile corresponding to the net error function of the first GFF component and the second GFF component and, optionally, other components of the gain-flattened optical amplifier.

15. The gain-flattened optical amplifier of claim 14 wherein the first GFF subcomponent and the pre-amplification stage of the optical signal amplifier and, optionally, other components of the gain-flattened optical amplifier, are packaged together in a first housing, and the second GFF subcomponent and the boost amplification stage of the optical signal amplifier and, optionally, other components of the gain-flattened optical amplifier, are packaged together in a second housing.

16. The gain-flattened optical amplifier of claim 14 wherein the pre-amplification stage comprises a first length of erbium-doped optical fiber and the boost amplification stage comprises a second length of erbium-doped optical fiber.

17. The gain-flattened optical amplifier of claim 14 wherein the first GFF subcomponent comprises a single thin-film gain-flattening filter, the second GFF subcomponent comprises a single thin-film gain-flattening filter and the second GFF component comprises a single thin-film gain-flattening filter.

18. Gain-flattening filter apparatus for in-line compensation of the spectral gain profile of an EDFA for signals in the C-band, comprising:
a. a first GFF component comprising at least one thin-film filter and having a transmission curve in the C-band with a spectral loss profile corresponding to an EDFA spectral gain profile in the C-band, and
b. a second GFF component comprising at least one thin-film filter and having a transmission curve in the C-band with a spectral loss profile corresponding to the error function of the first GFF component.

19. The gain-flattening filter apparatus in accordance with claim 18, for in-line compensation of the spectral gain profile of an EDFA for signals in the C-band, wherein the first GFF component comprises at least a first gain-flattening filter and a second gain-flattening filters, wherein the second gain-flattening filter has a transmission curve in the C-band with a spectral loss profile corresponding to an EDFA spectral gain profile in the C-band adjusted to correspond in part to the error function of the first gain-flattening filter.

20. The gain-flattening filter apparatus in accordance with claim 19 for in-line compensation of the spectral gain profile of an EDFA for signals in the C-band, further comprising an AR (anti-reflection) coating on a second surface of the at least one thin-film filter of the first optically transparent substrate and an AR coating on a second surface of the at least one thin-film filter of the second GFF component.

21. The gain-flattening filter apparatus in accordance with claim 18, for in-line compensation of the spectral gain profile of an EDFA for signals in the C-band, further comprising:
c. a housing,
d. a first ferrule disposed in the housing and providing an input optical fiber for carrying optical signals into the housing, and
e. a second ferrule disposed in the housing and providing an output optical fiber for carrying optical signals out of the housing,
wherein the first and second GFF components are housed in the housing between the first and second ferrules.

22. The gain-flattening filter apparatus in accordance with claim 18, for in-line compensation of the spectral gain profile of an EDFA for signals in the C-band, wherein the peak loss of the first GFF component in the C-band is at least three times the peak loss of the second GFF component in the C-band.

23. The gain-flattening filter apparatus in accordance with claim 18, for in-line compensation of the spectral gain profile of an EDFA for signals in the C-band, wherein the peak loss of the first GFF component in the C-band is at least four times the peak loss of the second GFF component in the C-band.

24. The gain-flattening filter apparatus in accordance with claim 18, for in-line compensation of the spectral gain profile of an EDFA for signals in the C-band, wherein the peak loss of the first GFF component in the C-band is at least 5 dB and the peak loss of the second GFF component in the C-band is less than 2 dB.

25. The gain-flattening filter apparatus in accordance with claim 18, for in-line compensation of the spectral gain profile of an EDFA for signals in the C-band, wherein the peak loss in the C-band of the first GFF component and second GFF component combined is at least 8 dB.

26. The gain-flattening filter apparatus in accordance with claim 25, for in-line compensation of the spectral gain profile of an EDFA for signals in the C-band, wherein the peak loss of the first GFF component in the C-band is at least three times the peak loss of the second GFF component in the C-band.

27. The gain-flattening filter apparatus in accordance with claim 25, for in-line compensation of the spectral gain profile of an EDFA for signals in the C-band, wherein the net insertion loss error function (PPEF) in the C-band of the first GFF component and second GFF component combined is less than 0.3 dB.

28. The gain-flattening filter apparatus in accordance with claim 25, for in-line compensation of the spectral gain profile of an EDFA for signals in the C-band, wherein the net insertion loss error function (PPEF) in the C-band of the first GFF component and second GFF component combined is less than 0.2 dB.

29. Gain-flattening filter apparatus for in-line compensation of the spectral gain profile of an optical amplifier, comprising:
a. a first GFF component comprising at least one thin-film filter, and
b. a second GFF component comprising at least one thin-film filter;
wherein the peak loss of the first GFF component is at least three times the peak loss of the second GFF component.

30. Gain-flattening filter apparatus for in-line compensation of the spectral gain profile of an optical amplifier, comprising:
a. a first GFF component comprising at least one thin-film filter, and
b. a second GFF component comprising at least one thin-film filter;
wherein the peak loss of the first GFF component is at least 5 dB and the peak loss of the second GFF component is less than 2 dB.

31. Gain-flattening filter apparatus for in-line compensation of the spectral gain profile of an optical amplifier over a range of optical signal wavelengths, comprising:
a. a first GFF component comprising at least one thin-film filter, and designed to have a transmission curve with a spectral loss profile matching a target loss profile corresponding to the spectral gain profile of the optical amplifier over said range of optical signal wavelengths; and
b. a second GFF component comprising at least one thin-film filter, and designed to have a transmission curve with a spectral loss profile corresponding to the error function of the first GFF component, where the error function is the measured difference between the actual spectral loss profile of the first GFF component and the target loss profile.

32. The gain-flattening filter apparatus in accordance with claim 31, for in-line compensation of the spectral gain profile of an optical amplifier over a range of optical signal wavelengths, wherein the peak loss over the range of optical signal wavelengths of the first GFF component and second GFF component combined is at least 8 dB.

33. The gain-flattening filter apparatus in accordance with claim 31, for in-line compensation of the spectral gain profile of an optical amplifier over a range of optical signal wavelengths, wherein the net insertion loss error function (PPEF) over the range of optical signal wavelengths of the first GFF component and second GFF component combined is less than 0.3 dB.

34. The gain-flattening filter apparatus in accordance with claim 31, for in-line compensation of the spectral gain profile of an optical amplifier over a range of optical signal wavelengths, wherein the net insertion loss error function (PPEF) over the range of optical signal wavelengths of the first GFF component and second GFF component combined is less than 0.2 dB.

35. The gain-flattening filter apparatus in accordance with claim 31, for in-line compensation of the spectral gain profile of an optical amplifier over a range of optical signal wavelengths, wherein the peak loss of the first GFF component over the range of optical signal wavelengths is at least three times the peak loss of the second GFF component over the range of optical signal wavelengths.

36. The gain-flattening filter apparatus in accordance with claim 31, for in-line compensation of the spectral gain profile of an optical amplifier over a range of optical signal wavelengths, wherein the peak loss of the first GFF component over the range of optical signal wavelengths is at least four times the peak loss of the second GFF component over the range of optical signal wavelengths.

37. The gain-flattening filter apparatus in accordance with claim 31, for in-line compensation of the spectral gain profile of an optical amplifier over a range of optical signal wavelengths, wherein the peak loss of the first GFF component over the range of optical signal wavelengths is at least 5 dB and the peak loss of the second GFF component over the range of optical signal wavelengths is less than 2 dB.

38. A gain-flattened optical signal amplifier comprising:
a. at least one optical signal amplifier operative to receive, amplify and output optical signals in an optical signal wavelength range, wherein the optical signal amplifier has a spectral gain profile; and
b. a gain-flattening filter for in-line compensation of the spectral gain profile of the at least one optical fiber amplifier for signals in the optical signal wavelength range, comprising:
i. a first GFF component comprising at least one thin-film filter and having a transmission curve in the optical signal wavelength range with a spectral loss profile corresponding to the spectral gain profile of the optical signal amplifier, and
ii. a second GFF component comprising at least one thin-film filter and having a transmission curve in the optical signal wavelength range with a spectral loss profile corresponding to the error function of the first GFF component.

39. The gain-flattened optical signal amplifier of claim 38 wherein the at least one optical signal amplifier is an optical fiber amplifier.

40. The gain-flattened optical signal amplifier of claim 38 wherein the at least one optical signal amplifier is an erbium-doped optical fiber amplifier and the optical signal wavelength range is the C-band

41. The gain-flattened optical signal amplifier of claim 38 wherein the at least one optical signal amplifier is a doped optical fiber amplifier and the optical signal wavelength range is the L-band.

42. The gain-flattened optical signal amplifier of claim 38 wherein the at least one optical signal amplifier is a doped optical fiber amplifier and the optical signal wavelength range is the S-band.

43. A method of producing a gain-flattening filter for use with an optical amplifier, comprising:
designing a first GFF component to have a transmission curve with a spectral loss profile corresponding to a target loss profile for the optical amplifier;
manufacturing the first GFF component;
determining the error function of the first GFF component;
designing a second GFF component to have a transmission curve with a spectral loss profile corresponding to the error function of the first GFF component;
manufacturing the second GFF component; and
combining the first GFF component with the second GFF component.

44. The method of claim 43 wherein the error function of the first GFF component is measured while the first GFF component is in assembly with at least certain other components of the GFF apparatus.

45. The method of claim 43 wherein the error function of the first GFF component is measured while the first GFF component is in assembly with at least certain other components of the gain-flattened amplifier.

46. The method of claim 43 wherein the error function of the first GFF component is measured while the first GFF component is in assembly with at least certain other components of the first GFF component and an optical amplifier of the gain-flattened amplifier.
